(19) United States
(12) Patent Application Publication
(10) Pub. No.: US 2026/0177402 A1
(43) Pub. Date: Jun. 25, 2026

(54) METHOD AND DEVICE FOR CREATING A DIGITAL MAP

(71) Applicant: Robert Bosch GmbH, Stuttgart (DE)

(72) Inventors: Jan Rohde, Dettingen Unter Teck (DE); Philipp Rasp, Reusten (DE)

(21) Appl. No.: 19/422,961

(22) Filed: Dec. 17, 2025

(30) Foreign Application Priority Data
Dec. 23, 2024 (DE) 10 2024 139 603.2

(51) Int. Cl. G01C 21/00

(52) U.S. Cl. CPC G01C 21/3852; G01C 21/3885

(57) ABSTRACT

A method and device for creating a digital map. The method includes: receiving surrounding region data value sets from a plurality of vehicles, wherein each surrounding region data value set was detected by means of a surrounding region sensor system of the particular vehicle and represents static and dynamic objects in a surrounding region of the vehicle; determining first map features from the surrounding region data value sets, each first map feature representing a description of one of the static objects; determining second map features, wherein a movement behavior of at least a subset of the dynamic objects is determined, and correlated with the first map features, wherein, the second map features are derived from the movement behavior correlated with the first map features; verifying the previously determined second map features; creating the digital map depending on the first and verified second map features; and providing the digital map.

### CROSS REFERENCE

The present application claims the benefit under 35 U.S.C. § 119 of Germany Patent Application No. DE 10 2024 139 603.2 filed on Dec. 23, 2024, which is expressly incorporated herein by reference in its entirety.

### FIELD

The present invention relates, among other things, to a method for creating a digital map, including: a step of receiving a plurality of surrounding region data value sets; a step of determining first map features from the surrounding region data value sets, wherein each first map feature represents a description of a static object; a step of determining second map features depending on a movement behavior of dynamic objects and the first map features; a step of verifying the previously determined second map features; a step of creating the digital map depending on the first and verified second map features; and a step of providing the digital map.

### SUMMARY

According to an example embodiment of the present invention, the method for creating a digital map comprises: a step of receiving a plurality of surrounding region data value sets from a plurality of vehicles, wherein each surrounding region data value set was detected by means of a surrounding region sensor system of the particular vehicle and represents static and dynamic objects in a surrounding region of the particular vehicle; a step of determining first map features from the surrounding region data value sets, wherein each first map feature represents a description of one of the static objects; and a step of determining second map features, wherein a movement behavior of at least a subset of the dynamic objects is, in a first substep, determined and, in a second substep, correlated with the first map features, wherein, in a third substep, the second map features are derived from the movement behavior correlated with the first map features. The method further comprises: a step of verifying the previously determined second map features; a step of creating the digital map depending on the first and verified second map features; and a step of providing the digital map.

A digital map is understood to mean a map that is present in the form of (map) data values on a storage medium. For example, the map is designed to comprise one or more map layers, wherein one map layer, for example, shows a map from a bird's eye view (course and position of roads, buildings, landscape features, etc.). This corresponds to a map of a navigation system, for example. A further map layer comprises, for example, a radar map, wherein surrounding region features comprised by the radar map are stored along with a radar signature. A further map layer comprises, for example, a lidar map, wherein surrounding region features comprised by the lidar map are stored along with a lidar signature.

In one example embodiment of the present invention, the map is designed as a highly accurate map. The highly accurate map is in particular designed in such a way that it is suitable for the navigation of an automated vehicle. This is understood to mean, for example, that the highly accurate map is designed to determine a highly accurate position of the automated vehicle by comparing stored surrounding region features to detected sensor data values of this automated vehicle. For this purpose, the highly accurate map, for example, comprises said surrounding region features along with highly accurate position specifications (coordinates). In this context, a map is in particular understood to mean a globally accurate map.

A highly accurate position is understood to mean a position which is accurate within a specified coordinate system, e.g., WGS84 coordinates, in such a way that this position does not exceed a maximum permitted uncertainty. The maximum uncertainty may depend on the surrounding region, for example. Furthermore, the maximum uncertainty can depend, for example, on whether a vehicle is operated manually or in a semi-, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

A vehicle is understood to mean a manually operated vehicle according to SAE level 0 or a semi-automated, highly automated or fully automated vehicle in accordance with one of SAE levels 1 to 5 (see SAE J3016 standard).

According to an example embodiment of the present invention, the detection of the surrounding region data value sets is carried out by means of the surrounding region sensor system. A surrounding region sensor system is understood to mean at least one video sensor and/or at least one radar sensor and/or at least one lidar sensor and/or at least one ultrasonic sensor and/or at least one further sensor that is designed to detect a surrounding region of a vehicle—in particular, the surrounding region features (here: static and/or dynamic objects) of this surrounding region—in the form of sensor data values. In one possible embodiment, the surrounding region sensor system comprises, for example, a computing unit (processor, working memory, hard drive) with suitable software and/or is connected to such a computing unit for this purpose.

A static object can be, for example, traffic signs (road signs, traffic lights, etc.), infrastructure features (guard rails, bridge pillars, road boundaries, etc.), buildings, etc. A dynamic object is understood here to mean, for example, an object that is currently moving. These could, for example, be other vehicles, pedestrians, cyclists, etc.

A surrounding region is understood here to mean at least one region—for example along the traffic route—that can be driven on by vehicles. The surrounding region comprises not only the traffic route itself, but also regions along the traffic route that are likewise able to be detected by means of a surrounding region sensor system when driving along the traffic route.

The first and/or second map features are understood to mean features in the digital map that represent surrounding region features—in particular static objects—in the particular surrounding region of a vehicle.

A description of a static object is understood to mean, for example, a position description (in WGS84 coordinates, in relation to the particular vehicle that detects the object, etc.) and/or a classification of the object (e.g., as a traffic sign, road marking, building, etc.) and/or further details (content of a road sign, color of a traffic light at the moment of detection, number of lanes with direction of travel, etc.).

According to an example embodiment of the present invention, the determination of the second map features is carried out by means of a plurality of substeps. A movement behavior of at least a subset of the dynamic objects is, in a first substep, determined. This includes, for example, an average speed of vehicles along a section of a traffic route. This movement behavior is, in a second substep, correlated with the first map features. The movement behavior determined above is linked to the first map features in a position-dependent manner. For example, the section of the traffic route described above is linked with further information (first map features) such as traffic signs, road markings, road width, etc. In the third substep, the second map features are then derived from the movement behavior correlated with the first map features. For example, if the aforementioned average speed at a certain location or along a certain traffic route is below a predetermined minimum value, the first map features (or the corresponding static objects) can be used to deduce whether, for example, there is a permanent cause (e.g., a toll booth, etc.) or a temporary cause (e.g., traffic jams at certain times, an accident, etc.).

Creating the digital map is understood to mean, for example, that the first and/or second map features are newly integrated into a base map according to their position and/or corresponding map features already comprised by the base map are removed or adjusted. Here, a base map is understood to mean in particular a digital map (as described above). The creation of the digital map is carried out in particular by means of a sequence of individual (computer-based) processes which are executed sequentially and/or at least partially in parallel. For example, individual processes are designed to organize, filter and analyze the corresponding data. This includes, for example, processing raw data to remove noise and extract accurate information. The data can also be used to identify and classify objects such as road signs, pedestrians, vehicles and other road users. In addition, the data can be used to create precise 3D models of the surrounding region, which are used for map generation. Digital maps are created based on the processed data. This can comprise creating vector or raster maps that include roads, buildings, traffic signs, traffic lights, and other features. The maps can also include additional information such as speed limits, traffic density and other relevant data. Map generation can also comprise the integration of different data types and the creation of maps at different scales and in different formats to meet the requirements of different navigation applications.

The method according to an example embodiment of the present invention advantageously achieves the object of providing a method for creating a digital map with information (here: the second map features) that can often only be generated using special sensor systems and at correspondingly high costs. The aforementioned object is now achieved by means of the method according to the present invention, in particular by—directly—determining first map features from a plurality of surrounding region data value sets from a plurality of vehicles. Subsequently, the second map features, which are only indirectly accessible, are determined therefrom. This allows—in addition to the directly measurable information from the surrounding region data value sets-further information to be determined or derived in a cost-efficient manner, which information can likewise be integrated into the digital map.

Preferably, according to an example embodiment of the present invention, providing the digital map comprises aggregating the digital map with a previously created behavior map.

A behavior map comprises information about the behavior of other road users (here: static objects). Aggregating the digital map with a previously created behavior map results in a further digital map which can be used, for example, to activate and deactivate certain ADAS driving functions.

Preferably, the verification is carried out by comparing the second map features to satellite-based comparison data.

Preferably, the movement behavior comprises speeds and/or accelerations and/or directions of movement.

According to an example embodiment of the present invention, the device, in particular a computing unit, is configured to perform all steps of the method for creating a digital map according to the present invention. A computing unit is understood to mean, for example, a server or a server network/a cloud.

The device or computing unit comprises a processor, a working memory, a storage medium, and suitable software in order to perform the method according to one of the method claims. Furthermore, the device comprises an interface in order to transmit and receive data values by means of a wired and/or wireless connection, for example to corresponding devices of vehicles (control units, communication devices, a surrounding region sensor system, a navigation system, etc.) and/or further off-board devices (server, cloud, etc.).

Furthermore, a computer program is provided, comprising commands that, when the computer program is executed by a computer, cause the computer to perform a method according to one of the embodiments of the method for creating a digital map according to the present invention. In one example embodiment of the present invention, the computer program corresponds to the software comprised by the second device.

Furthermore, a machine-readable storage medium on which the computer program is stored is provided according to the present invention.

Advantageous developments of the present invention are disclosed herein.

### BRIEF DESCRIPTION OF THE DRAWING

Exemplary embodiments of the present invention are explained in more detail in the following description and are illustrated in the FIGURE.

FIG. 1 shows an exemplary embodiment of the method according to the present invention for creating a digital map in the form of a flow chart.

### DETAILED DESCRIPTION OF EXMPLE EMBODIMENTS

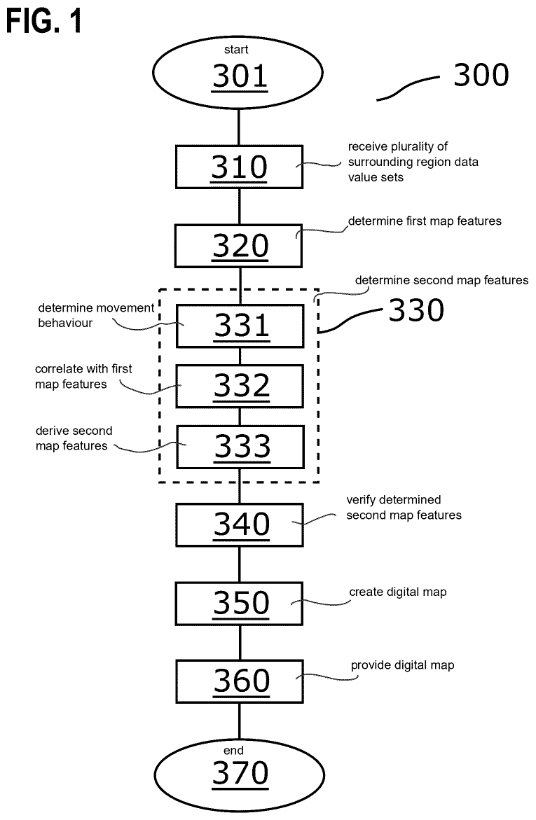

FIG. 1 shows an exemplary embodiment of a method 300 for creating 350 a digital map.

In step 301, the method 300 starts.

In step 310, a plurality of surrounding region data value sets are received from a plurality of vehicles, wherein each surrounding region data value set was detected by means of a surrounding region sensor system of the particular vehicle and represents static and dynamic objects in a surrounding region of the particular vehicle.

In step 320, first map features are determined from the surrounding region data value sets, wherein each first map feature represents a description of one of the static objects.

In step 330, second map features are determined, wherein a movement behavior of at least a subset of the dynamic objects is, in a first substep 331, determined and, in a second substep 332, correlated with the first map features, wherein, in a third substep 333, the second map features are derived from the movement behavior correlated with the first map features.

In step 340, the previously determined second map features are verified.

In step 350, the digital map is created depending on the first and verified second map features.

In step 360, the digital map is provided.

In step 370, the method 300 ends.

What is claimed is:

1. A method for creating a digital map, comprising the following steps:
receiving a plurality of surrounding region data value sets from a plurality of vehicles, wherein each respective surrounding region data value set of the plurality of surrounding region data value sets was detected by means of a surrounding region sensor system of a respective vehicle of the plurality of vehicles, and represents static and dynamic objects in a surrounding region of the respective vehicle;
determining first map features from the surrounding region data value sets, wherein each first map feature of the firt map features represents a description of one of the static objects;
determining second map features, wherein a movement behavior of at least a subset of the dynamic objects is, in a first substep, determined and, in a second substep, correlated with the first map features, wherein, in a third substep, the second map features are derived from the movement behavior correlated with the first map features;
verifying the determined second map features;
creating the digital map depending on the first and verified second map features; and
providing the digital map.

2. The method according to claim 1, wherein the providing of the digital map includes aggregating the digital map with a previously created behavior map.

3. The method according to claim 1, wherein the verification is carried out by comparing the second map features to satellite-based comparison data.

4. The method according to claim 1, wherein the movement behavior includes speeds and/or accelerations and/or directions of movement.

5. A device, comprising:
a computing unit configured to create a digital map by performing the following steps including:
receiving a plurality of surrounding region data value sets from a plurality of vehicles, wherein each respective surrounding region data value set of the plurality of surrounding region data value sets was detected by means of a surrounding region sensor system of a respective vehicle of the plurality of vehicles, and represents static and dynamic objects in a surrounding region of the respective vehicle,
determining first map features from the surrounding region data value sets, wherein each first map feature of the firt map features represents a description of one of the static objects,
determining second map features, wherein a movement behavior of at least a subset of the dynamic objects is, in a first substep, determined and, in a second substep, correlated with the first map features, wherein, in a third substep, the second map features are derived from the movement behavior correlated with the first map features,
verifying the determined second map features,
creating the digital map depending on the first and verified second map features, and
providing the digital map.

6. A non-transitory machine-readable storage medium on which is stored a computer program creating a digital map, the computer program, when executed by a computer, causing the computer to perform the following steps:
receiving a plurality of surrounding region data value sets from a plurality of vehicles, wherein each respective surrounding region data value set of the plurality of surrounding region data value sets was detected by means of a surrounding region sensor system of a respective vehicle of the plurality of vehicles, and represents static and dynamic objects in a surrounding region of the respective vehicle;
determining first map features from the surrounding region data value sets, wherein each first map feature of the firt map features represents a description of one of the static objects;
determining second map features, wherein a movement behavior of at least a subset of the dynamic objects is, in a first substep, determined and, in a second substep, correlated with the first map features, wherein, in a third substep, the second map features are derived from the movement behavior correlated with the first map features;
verifying the determined second map features;
creating the digital map depending on the first and verified second map features; and
providing the digital map.
